(19) United States
(12) Patent Application Publication
(10) Pub. No.: US 2012/0033189 A1
(43) Pub. Date: Feb. 9, 2012

(54) PROJECTOR AND COLOR WHEEL MODULE THEREOF

(76) Inventor: Yuan Ming HSU, Taoyuan Hsien (TW)

(21) Appl. No.: 13/178,139

(22) Filed: Jul. 7, 2011

(30) Foreign Application Priority Data
Aug. 6, 2010 (TW) 99126180

(51) Int. Cl. G03B 21/14; G02B 5/22

(52) U.S. Cl. 353/84; 359/889

(57) ABSTRACT

A color wheel module is provided. The color wheel module includes a stator, a rotor, a color wheel and a sensor. The rotor surrounds the stator, wherein the rotor includes a rotor body, a turn table and a balance yoke, and the balance yoke is disposed on the turn table, and the balance yoke includes an N pole portion and an S pole portion, and the rotor body is tube shaped, and the turn table is disposed on an end of the rotor body. The color wheel is disposed on the rotor. The sensor corresponds to the balance yoke, wherein when the balance yoke is rotated, the N pole portion and the S pole portion are rotated to generate a magnetic field variation, and the sensor outputs an electric signal according to the magnetic field variation to define an initial position of the color wheel.

### CROSS REFERENCE TO RELATED APPLICATIONS

This Application claims priority of Taiwan Patent Application No. 099126180, filed on Aug. 6, 2010, the entirety of which is incorporated by reference herein.

### BACKGROUND OF THE INVENTION

1. Field of the Invention

The present invention relates to a color wheel module, and in particular relates to a color wheel assisting to define an initial position of a color wheel of the color wheel module.

2. Description of the Related Art

In a projector, to present correct color according to a control signal, an initial position of a color wheel is defined, and an index delay is controlled by a calculating method according to the detected initial position. Conventionally, an infrared reflective optical sensor is utilized in detecting an initial position of a color wheel. FIG. 1 shows a conventional method for detecting an initial position of a color wheel. A timing label 12 is attached to a shaft 11 of a color wheel 10. When the color wheel 10 is rotated, a sensor 1 emits a light beam toward the shaft 11. The light beam 2 is reflected by a surface of the shaft 11, and is received by the sensor 1. When the light beam 2 contacts the timing label 12, the light beam 2 is absorbed thereby, and is not received by the sensor 1. Thus, the sensor 1 sends an electrical signal according to the light receiving condition to define an initial position of the color wheel 10. However, the conventional method has the following defects:
(a) Light interference: Inner light of the projector may enter the infrared reflective optical sensor, generate light interference, and influence the initial position detection.
(b) Dust pollution: Dust may cover the light passage of the sensor, and influence the initial position detection.

### BRIEF SUMMARY OF THE INVENTION

A color wheel module is provided. The color wheel module includes a stator, a rotor, a color wheel and a sensor. The rotor surrounds the stator, wherein the rotor includes a rotor body, a turn table and a balance yoke, and the balance yoke is disposed on the turn table, and the balance yoke includes an N pole portion and an S pole portion, and the rotor body is tube shaped, and the turn table is disposed on an end of the rotor body. The color wheel is disposed on the rotor. The sensor corresponds to the balance yoke, wherein when the balance yoke is rotated, the N pole portion and the S pole portion are rotated to generate a magnetic field variation, and the sensor outputs an electric signal according to the magnetic field variation to define an initial position of the color wheel.

In the embodiment of the invention, the sensor outputs an electric signal (Hi/Lo electric signal) according to the magnetic field variation to define an initial position of the color wheel, and an index delay is controlled by a calculating method according to the detected initial position to show a correct color. Compared to the conventional method, the color wheel module of the embodiment of the invention has no light interference or dust pollution problems; thus, the initial position of the color wheel can be defined accurately.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a conventional method for detecting an initial position of a color wheel;

FIG. 2 is an assembly view of a color wheel module of an embodiment of the invention;

FIG. 3 is an exploded view of the color wheel module of the embodiment of the invention;

FIG. 4 is a front view of a color wheel;

FIG. 5 is a sectional view of the color wheel;

FIG. 6A shows a sensor of the embodiment of the invention detecting a magnetic field variation;

FIG. 6B shows an electric signal (Hi/Lo electric signal) according to the magnetic field variation;

FIG. 7 shows a projector of another embodiment of the invention; and

FIGS. 8A and 8B show modified examples of the invention.

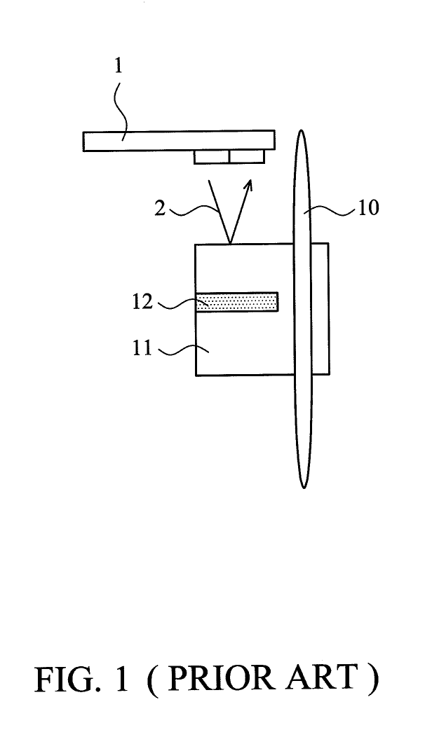

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

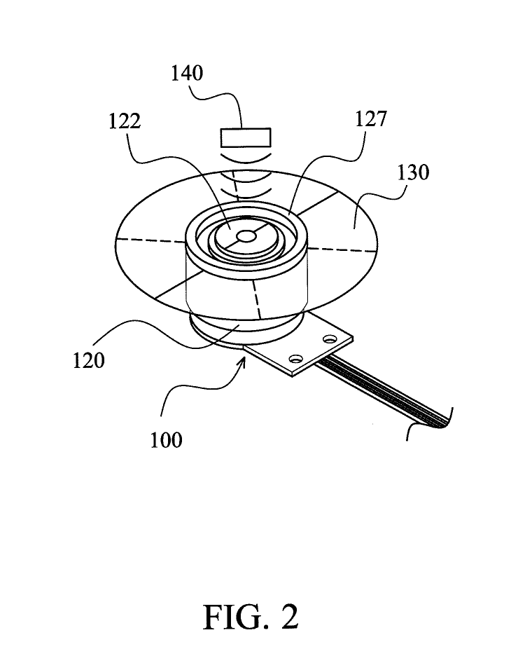

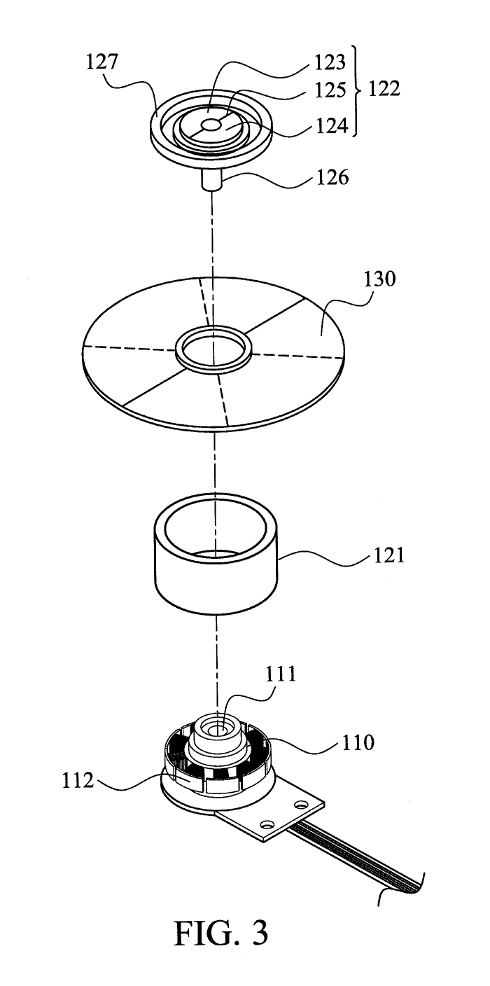

FIG. 2 is an assembly view of a color wheel module 100 of an embodiment of the invention, and FIG. 3 is an exploded view of the color wheel module 100 of the embodiment of the invention. With reference to FIGS. 2 and 3, the color wheel module 100 comprises a stator 110, a rotor 120, a color wheel 130 and a sensor 140. The rotor 120 surrounds the stator 110. The rotor 120 comprises a rotor body 121, a turn table 127 and a balance yoke 122. The balance yoke 122 is disposed on the turn table 127. The balance yoke 122 comprises an N pole portion 123, an S pole portion 124 and a pole border line 125. The pole border line 125 is located between the N pole portion 123 and the S pole portion 124. The rotor body 121 is tube shaped, and the turn table 127 is disposed on an end of the rotor body 121. The color wheel 130 is disposed on the rotor 120, and is sandwiched between the rotor body 121 and the balance yoke 122. The pole border line 125 corresponds to a particular portion of the color wheel 130.

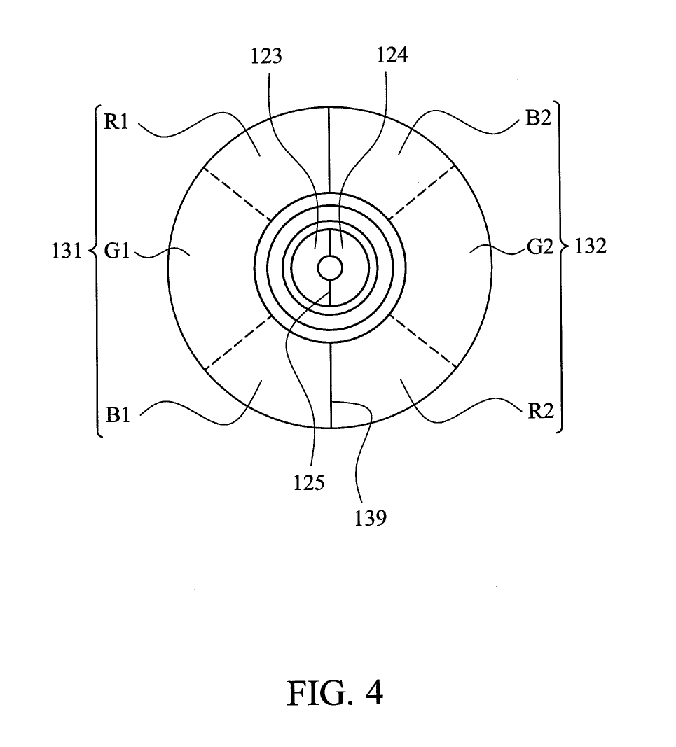

FIG. 4 is a front view of the color wheel 130. The color wheel 130 comprises a first color area 131, a second color area 132 and a color border line 139, and the color border line 139 and the pole border line 125 are collinear. The first color area 131 comprises a first red portion R1, a first green portion G1 and a first blue portion B1, and the second color area 132 comprises a second red portion R2, a second green portion G2 and a second blue portion B2, and the first green portion G1 is located between the first red portion R1 and the first blue portion B1, and the second green portion G2 is located between the second red portion R2 and the second blue portion B2, and the first red portion R1 is adjacent to the second blue portion B2, and the second red portion R2 is adjacent to the first blue portion B1.

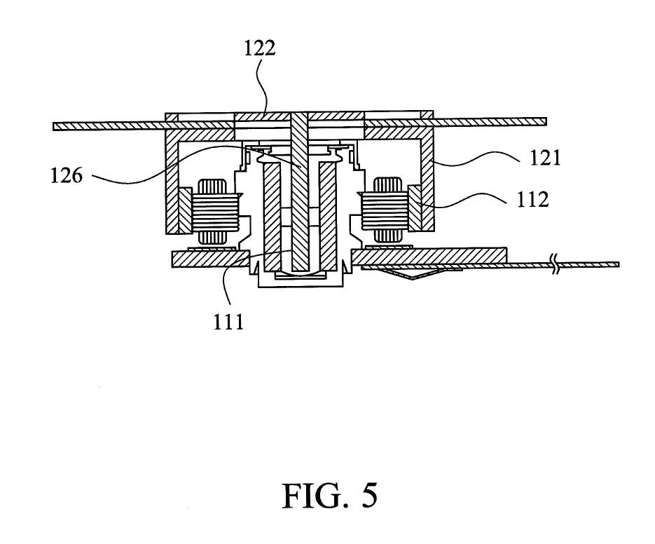

FIG. 5 is a sectional view of the color wheel 130. The rotor 120 further comprises a shaft 126, and the shaft 126 is disposed on the balance yoke 122. The stator 110 comprises a hole 111, and the shaft 126 is inserted into the hole 111. The rotor body 121 comprises a permanent magnet, and the stator 110 comprises a plurality of electromagnetic elements 112, and the electromagnetic elements 112 surround the hole 111, and the electromagnetic elements 112 are located between the hole 111 and the rotor body 121. The electromagnetic elements 112 are arranged equidistantly.

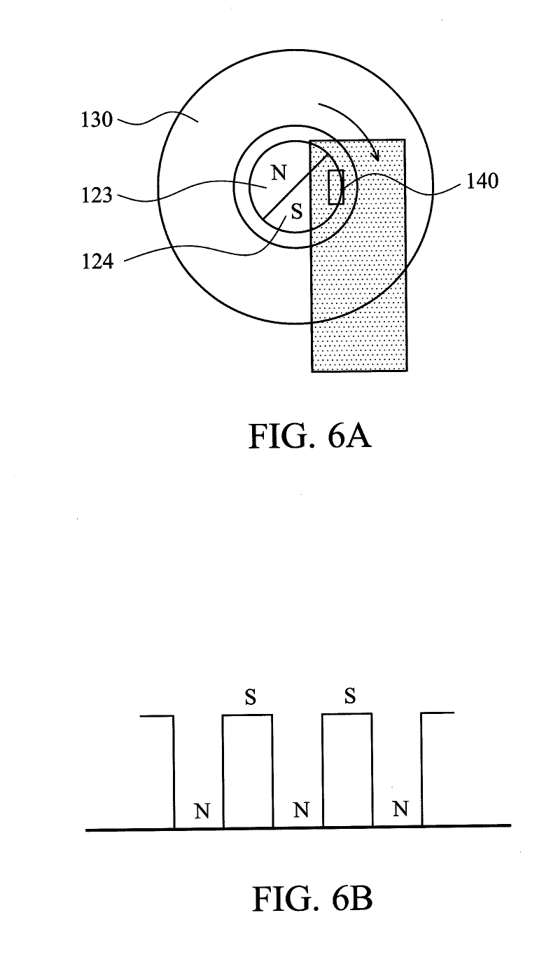

With reference to FIGS. 2, 6A and 6B, the sensor 140 corresponds to the balance yoke 122. When the color wheel 130 and the balance yoke 122 are rotated, the N pole portion 123 and the S pole portion 124 are rotated to generate a magnetic field variation. The sensor 140 outputs an electric signal (Hi/Lo electric signal) according to the magnetic field variation to define an initial position of the color wheel 130, and an index delay is controlled by a calculating method according to the detected initial position to show a correct color. Compared to the conventional method, the color wheel module of the embodiment of the invention has no light interference or dust pollution problems; thus, the initial position of the color wheel can be defined accurately.

Additionally, magnetic force generated by the N pole portion 123 and the S pole portion 124 also pass the turn table 127. Therefore, in one embodiment, the sensor 140 can be disposed on a side of the turn table 127 (not shown) to detect the magnetic field variation of the balance yoke 122.

In the embodiment above, the color wheel 130 comprises a first red portion R1, a first green portion G1, a first blue portion B1, a second red portion R2, a second green portion G2 and a second blue portion B2. However, the invention is not limited. The color wheel 130 can be modified. For example, the color wheel can have only one red portion, one green portion and one blue portion, or the color wheel can have one red portion, one green portion, one blue portion and one transparent portion.

In the embodiment above, the color border line and the pole border line are collinear. However, the invention is not limited. The pole border line can correspond to any position of the color wheel, and the calculating method can be modified to control index delay and to show a correct color.

In the embodiment above, the external rotor DC brushless motor is utilized. However, the invention is not limited. Motors of other types can also be utilized in the invention.

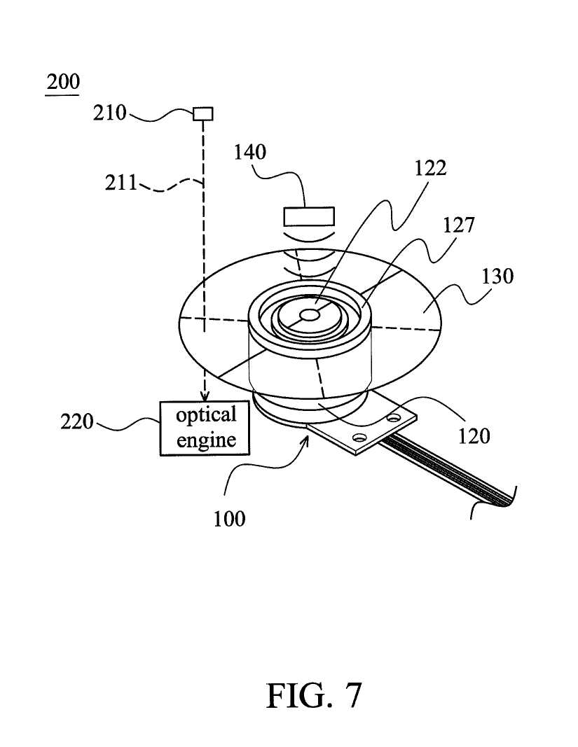

FIG. 7 shows a projector 200 of another embodiment of the invention, which comprises a light source 210, an optical engine 220 and the color wheel 100 mentioned above. The light source 210 provides a light beam 211. The light beam 211 passes through the color wheel module 100 to the optical engine 220. The sensor 140 is located between the color wheel 130 and the light source 210.

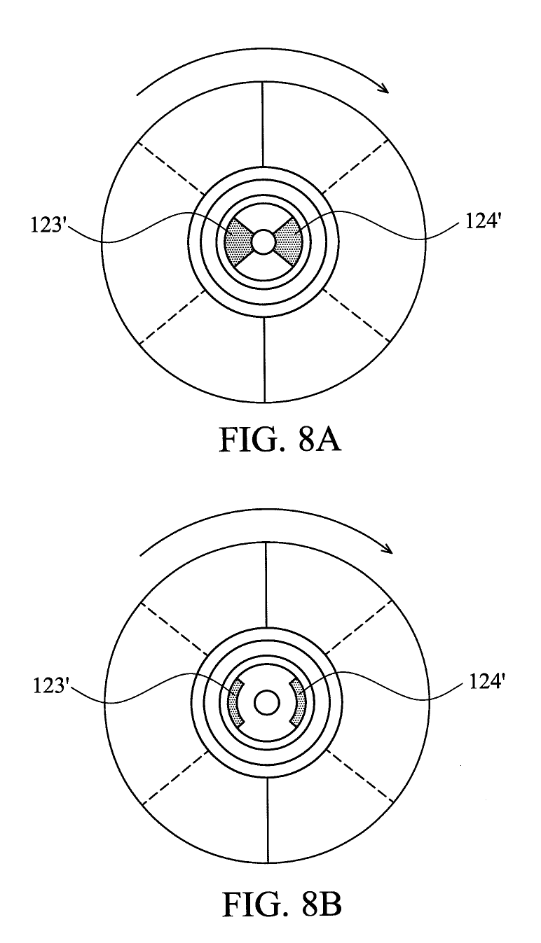

FIGS. 8A and 8B show modified examples of the invention, wherein a non-magnetic area is formed between the N pole portion 123′ and the S pole portion 124′. The N pole portion 123′ does not close neighbor on the S pole portion 124′. As shown in FIGS. 8A and 8B, the N pole portion 123′ and the S pole portion 124′ can be modified.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A color wheel module, comprising:
a stator;
a rotor, surrounding the stator, wherein the rotor comprises a rotor body, a turn table and a balance yoke, and the balance yoke is disposed on the turn table, and the balance yoke comprises an N pole portion and an S pole portion, and the rotor body is tube shaped, and the turn table is disposed on an end of the rotor body;
a color wheel, disposed on the rotor; and
a sensor, corresponding to the balance yoke, wherein when the balance yoke is rotated, the N pole portion and the S pole portion are rotated to generate a magnetic field variation, and the sensor outputs an electric signal according to the magnetic field variation to define an initial position of the color wheel.

2. The color wheel module as claimed in claim 1, wherein the balance yoke further comprises a pole border line, and the pole border line is located between the N pole portion and the S pole portion, and the color wheel comprises a first color area, a second color area and a color border line, and the color border line and the pole border line are collinear.

3. The color wheel module as claimed in claim 2, wherein the first color area comprises a first red portion, a first green portion and a first blue portion, and the second color area comprises a second red portion, a second green portion and a second blue portion, and the first green portion is located between the first red portion and the first blue portion, and the second green portion is located between the second red portion and the second blue portion, and the first red portion is adjacent to the second blue portion, and the second red portion is adjacent to the first blue portion.

4. The color wheel module as claimed in claim 1, wherein the rotor further comprises a shaft, and the shaft is disposed on the balance yoke, and the stator comprises a hole, and the shaft is inserted into the hole.

5. The color wheel module as claimed in claim 4, wherein the rotor body comprises a permanent magnet, and the stator comprises a plurality of electromagnetic elements, and the electromagnetic elements surround the hole, and the electromagnetic elements are located between the hole and the rotor body.

6. The color wheel module as claimed in claim 5, wherein the electromagnetic elements are arranged equidistantly.

7. A projector, comprising:
a light source, providing a light beam;
an optical engine; and
a color wheel module, wherein the light beam passes through the color wheel module to the optical engine, comprising:
a stator;
a rotor, surrounding the stator, wherein the rotor comprises a rotor body, a turn table and a balance yoke, and the balance yoke is disposed on the turn table, and the balance yoke comprises an N pole portion and an S pole portion, and the rotor body is tube shaped, and the turn table is disposed on an end of the rotor body;
a color wheel, disposed on the rotor, wherein the light beam passes through the color wheel; and
a sensor, corresponding to the balance yoke, wherein when the balance yoke is rotated, the N pole portion and the S pole portion are rotated to generate a magnetic field variation, and the sensor outputs an electric signal according to the magnetic field variation to define an initial position of the color wheel.

8. The projector as claimed in claim 7, wherein the balance yoke further comprises a pole border line, and the pole border line is located between the N pole portion and the S pole portion, and the color wheel comprises a first color area, a second color area and a color border line, and the color border line and the pole border line are collinear.

9. The projector as claimed in claim 8, wherein the first color area comprises a first red portion, a first green portion and a first blue portion, and the second color area comprises a second red portion, a second green portion and a second blue portion, and the first green portion is located between the first red portion and the first blue portion, and the second green portion is located between the second red portion and the second blue portion, and the first red portion is adjacent to the second blue portion, and the second red portion is adjacent to the first blue portion.

10. The projector as claimed in claim 7, wherein the rotor further comprises a shaft, and the shaft is disposed on the balance yoke, and the stator comprises a hole, and the shaft is inserted into the hole.

11. The projector as claimed in claim 10, wherein the rotor body comprises a permanent magnet, and the stator comprises a plurality of electromagnetic elements, and the electromagnetic elements surround the hole, and the electromagnetic elements are located between the hole and the rotor body.

12. The projector as claimed in claim 11, wherein the electromagnetic elements are arranged equidistantly.

13. The projector as claimed in claim 7, wherein the sensor is located between the color wheel and the light source.
